(19) United States
(12) Patent Application Publication
(10) Pub. No.: US 2008/0234451 A1
(43) Pub. Date: Sep. 25, 2008

(54) Olefin Metathesis Polymerisation

(75) Inventors: Alan Michael Kenwright, Chester-le-Street (GB); David Mitchell Haigh, Cambridgeshire (GB); Ezat Khosravi, Durham (GB)

Correspondence Address: JONES DAY, 222 EAST 41ST ST, NEW YORK, NY, 10017, US

(73) Assignee: Imperial Chemical Industries PLC, London (GB)

(21) Appl. No.: 11/794,096

(22) PCT Filed: Dec. 5, 2005
(86) PCT No.: PCT/GB05/04664

§ 371 Date: Apr. 11, 2008

(30) Foreign Application Priority Data
Dec. 23, 2004 (GB) 0428172.1

(51) Int. Cl. C08F 4/72; C08F 22/10

(52) U.S. Cl. 526/171; 526/321; 526/90; 556/19

(57) ABSTRACT

A ring-opening metathesis polymerisation (ROMP) reaction is disclosed in which a cyclic alkene compound is subjected to ROMP using a transition metal ROMP catalyst which has an alkyl moiety which is connected to the metal centre thereof through a double bond. The process includes the step of adding sufficient of an acyclic alkene having a carbon-carbon double bond capable of reacting with the catalytic metal moieties attached to the living end of each of the polymer chains generated in the ROMP reaction to end cap the polymer chains and to generate a stable olefin metathesis catalyst.

The invention relates to olefin metathesis polymerisation and, In particular, to ring-opening metathesis polymerisations (ROMP) and especially to the recovery of catalysts used in such polymerisations.

Olefin metathesis reactions concern the exchange of groups around double bonds between carbon atoms. The ability to perform olefin metathesis reactions is of significant commercial interest which interest has been increased in recent years owing to significant developments in transition metal initiators and catalysts, especially metal carbene initiators and catalysts, for such reactions. A useful review by A Maureen Rouhi of olefin metathesis has appeared in Chemical & Engineering News, Volume 80, Number 51, CENEAR 80 51 pp. 29-33, ISSN 0009-2347.

In many metathesis reactions involving ring-closing metathesis (RCM), cross metathesis (CM) and asymmetric ring-opening/cross metathesis (AROM/CM), the transition metal compound or complex is recoverable in viable quantities. Examples of such catalysts are disclosed in “A Recyclable Ru-Based Metathesis Catalyst”, Hoveyda et al, J Am Chem Soc, 1999, 121, 791-799; “Recent Advances in the Synthesis of Supported Metathesis Catalysts”, Buchmeiser, New. J. Chem., 2004, 28, 549-557; US-A-2002/0107138—Hoveyda et al (equivalent to WO 02/014376); US-A-2003/0064884—Yao; US-A-2004/0019212—Hoveyda et al; In Situ Preparation of a Highly Active N-Heterocyclic Carbene-Coordinated Olefin Metathesis Catalyst, Morgan & Grubbs, Organic Letters 2000, Vol 2, No 20, 3153-3155; Efficient and Recyclable Monomeric and Dendritic Ru-Based Meathesis Catalysts, J Am Chem Soc, 2000, 122(34), 8168-8179, Garber et al; Highly Efficient Ring-Opening Metathesis Polymerisation (ROMP) Using New Ruthenium Catalysts Containing N-Heterocyclic Carbene Ligands, Bielawski & Grubbs, Chem. Int. Ed 2000, 39, No 16, 2903-2907; A Versatile Precursor for the Synthesis of New Ruthenium Olefin Metathesis Catalysts, Grubbs et al, Organometallics, 2001, 20, 5314-5318; Controlled Living Ring-Opening-Metathesis Polymerisation by a Fast-initiating Ruthenium Catalyst, Choi & Grubbs, Chem. Int. Ed 2003, 42, 1743-1746; Relative Reaction Rates of Olefin Substrates with Ruthenium(II) Carbene Metathesis Initiators, Ulman & Grubbs, Organometallics, 1998, 17, 2484-2489; U.S. Pat. No. 6,486,263 B2—Fogg et al; and The First Highly Active, Halide-Free Ruthenium Catalyst for Olefin Metathesis, Conrad et al, Organometallics 2003, 22, 3634-3636. The mechanism of recovery of the catalyst appears to involve the recombination of the active transition metal with a carbene moiety that may have been displaced from the transition metal during the reaction. As the concentration of reactant(s) is lowered as the reaction nears completion, the carbene moiety reacts with the transition metal to reform a catalyst. The catalyst may then be separated from the reaction mixture by any suitable separation technique; for example by chromatography, precipitation and filtration (the latter technique is especially useful when the catalyst is a supported catalyst).

In contrast, when such catalysts are used in ROMP reactions, owing to the kinetics involved, the transition metal moiety catalysing the reaction usually remains attached to the resultant polymer chains. Consequently, it is necessary to cleave the transition metal moiety from the polymer. A number of reagents may be used to effect cleavage of the metal, a common example being ethyl vinyl ether (CH2=CHOCH2CH3) as described on page 6, [0062] of US-A 2003/0064884 referred to above. Such cleavage or end-capping agents may terminate the polymer chains or may be used to add in functionality to ends of the polymer chains. However, using methods previously proposed leads to either a transition metal species which is metathesis inactive or to a transition metal species which is metathesis active but which is unstable and rapidly decomposes to one which is inactive.

The Applicants have found the surprisingly simple step of adding, at the end of the polymerisation reaction, a suitable alkene results in the regeneration of the same catalyst or the production of a different stable catalyst.

Thus, according to the present invention, a polymerisation process comprises:
a) subjecting a cyclic alkene compound to a ring-opening metathesis polymerisation (ROMP) reaction using a transition metal ROMP catalyst which has an alkyl moiety which is connected to the metal centre thereof through a double bond; and
b) adding sufficient of an acyclic alkene having a carbon-carbon double bond capable of reacting with the catalytic metal moieties attached to the living end of each of the polymer chains generated in step a) to end cap the polymer chains and to generate a stable olefin metathesis transition metal catalyst.

It will be understood that, in this specification, the term ring-opening metathesis polymerisation includes the generation of oligomeric species as well as polymeric species.

Preferably, the ROMP metal catalyst used in step a) of the process according to the invention is a transition metal catalyst, more preferably a molybdenum, tungsten, ruthenium, rubidium, rhodium or osmium catalyst; more particularly a molybdenum, ruthenium or osmium catalyst; and especially a ruthenium catalyst.

As is well understood in the art, in the case of a ruthenium catalyst, in addition to the alkyl moiety, the catalyst has two electron-withdrawing groups (for example halogen (which may be the same or different) or hetero-substituted aromatic groups or hetero-substituted aliphatic groups); and two electron-donating groups which may be the same or different (for example phosphine ligands such as PCy₃ (where Cy is a cyclic aliphatic ring, preferably cyclohexyl) or other heterocyclic groups or one such group may be, for example, oxygen attached to the alkyl moiety). In preferred catalysts for use in the process according to the invention, the alkyl moiety is an arylalkyl moiety. Such an arylalkyl moiety may itself be substituted on the aromatic ring.

Additionally, the catalysts may be attached to a support such as a polymeric support, for example a PEG polymer, or a solid support either through the arylalkyl moiety or through one or more of the electron-donating groups and/or electron-withdrawing groups.

Specific examples of such catalysts are disclosed in the publications referred to earlier, which references are hereby, incorporated herein by reference in their entirety.

Preferred catalysts according to the invention may have the formula:

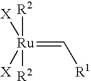

wherein:
R¹ is alkyl, aryl, alkylether, alkylthioether, arylether, arylthioether and in which, when R¹ contains an aryl component, the aryl component may be substituted, especially with electron withdrawing groups such as alkoxy groups;
R² are electron-donating groups which may be the same or different and are selected from PR₃³, wherein R³ is alkyl, such as isopropyl, or is Cy wherein Cy is a cyclic aliphatic ring, preferably cyclohexyl, or is Ph wherein Ph is an aromatic ring or a heterocyclic group, especially a heterocyclic group of formula:

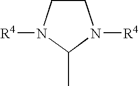

in which R⁴ is alkyl, aryl, arylalkyl; and
each X is an electron-withdrawing group which may the same or different and are selected from halogen, preferably chlorine, or hetero-substituted aromatic groups or hetero-substituted aliphatic groups such as aryloxy or alkoxy groups, especially phenoxy groups.

Such catalysts may have other ligands attached, for example pyridine ligands, which may be substituted for example with halogen, preferably Br.

Particularly preferred catalysts are the so-called Grubbs and Hoveyda catalysts. The Grubbs catalyst is RuCl₂(═CHC₆H₅)(PCy₃)₂ and the Hoveyda catalyst is:

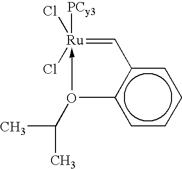

Also, derivatives of these catalysts are preferred. Such derivatives are described in the references above.

The acyclic alkene used in step b) may have the double bond either at the end of the alkyl chain or between the ends. More preferably, the alkene has a terminal double bond. The alkyl chain is lower alkyl, for example between C₂ and C₁₂, preferably between C₂ and C₅. It may also have more than one double bond in the chain. Preferably, when the alkene is an arylalkene, the alkyl chain is a C₂ chain. When the alkene is an arylalkene, the aryl ring is preferably a single ring, which may be substituted. Preferably, the ring is substituted in the ortho position with an alkoxy moiety, for example a C₁ to C₁₂ alkoxy moiety, especially an isopropoxy moiety. Examples of preferred alkenes are hex-3-ene, styrene or 2-isopropoxystyrene. Preferably, in step b), the alkene is an arylalkene selected from styrene or 2-isopropoxystyrene.

Preferably, in step b), the polymerisation reaction is substantially completed prior to the addition of the alkene.

Preferably, in step b), the catalyst generated by the addition of the alkene is the same catalyst as used in step a). Alternatively, the catalyst generated by the addition of the alkene is a different catalyst. When the catalyst used in step a) is a supported catalyst and is attached to the support through the alkyl moiety, the catalyst generated in step b) is not attached to the support. When the catalyst used in step a) is a supported catalyst and is attached to the support through an electron-donating and/or electron-withdrawing group, the catalyst generated in step b) is attached to the support. Preferably, when a supported catalyst is used, it is attached to the support through an electron-donating and/or through an electron-withdrawing group.

Preferably, the amount of alkene used in step b) is at least one molar equivalent, and more especially is at least two molar equivalents. Preferably, the amount of alkene used in step b) is not more than 10 molar equivalents, more especially not more than 5 molar equivalents. The preferred range of alkene used in step b) is between 1 and 10 molar equivalents, more especially between 2 and 5 molar equivalents.

The invention also includes a stable olefin metathesis catalyst recovered from a process according to the invention.

The invention will now be further described by way of illustration only with reference to the accompanying drawing and following examples. In the drawing:

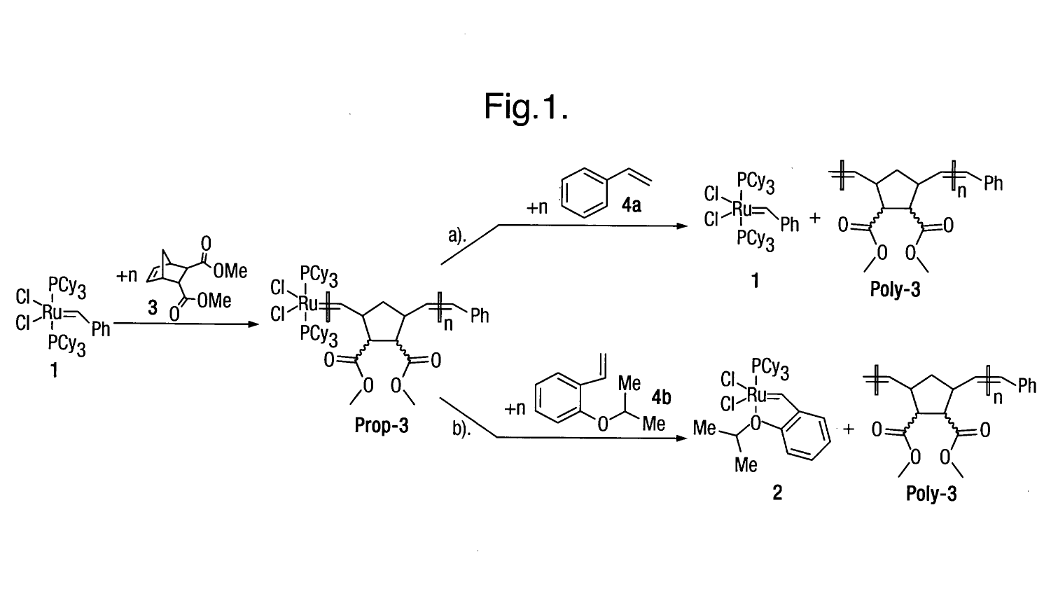

FIG. 1 is a reaction scheme showing the alternative routes described in Examples 1 and 2.

### EXAMPLE 1

A ring-opening olefin metathesis polymerisation as outlined in FIG. 1, route a) was carried out. Under an inert atmosphere, endo,exo-5,6-dicarbomethoxynorbornene (3) (67.6 mg, 0.32 mmol) dissolved in CDCl₃ (0.40 ml) was added to RuCl₂(PCy₃)₂(=CHPh) (1) (Cy=cyclohexyl; Ph=phenyl) (10.6 mg, 12.9 μmol) dissolved in CDCl₃ (0.40 ml). The reaction mixture was transferred to a Young's NMR tube. The system was monitored by ¹H NMR spectroscopy until the monomer was totally consumed (disappearance of monomer vinyl resonances at 6.10 and 6.25 ppm), ie the propagating species (Prop-3) had reacted substantially all of (3). After this time, (˜5 hours) styrene (4a) (2.7 mg, 25.9 μmol-2 molar equivalents) dissolved in CDCl₃ (0.1 ml) was added to the solution. An extra 0.1 ml CDCl₃ was added to the reaction mixture to ensure all the styrene had been added. The reaction was monitored by ¹H NMR spectroscopy. The NMR spectroscopy results showed cross metathesis occurred between the living chain-end of the polymer chains (Prop-3) and the styrene (4a) and led to the conversion of the propagating Ru moiety exclusively back to RuCl₂(PCy₃)₂(=CHPh) (1) and a chain-terminated polymer (Poly-3). A substantial part of the reaction had taken place within 15 minutes with it going fully to completion after 2 hours. After precipitation of the polymer (Poly-3) in deoxygenated solvent, the initiator (1) may be recovered and re-used in subsequent metathesis reactions.

The reaction was repeated using five molar equivalents of styrene and the conversion of the propagating species (Prop-3) to the catalyst (1) and polymer (Poly-3) was completed in 10 minutes.

### EXAMPLE 2

A ring-opening olefin metathesis polymerisation as outlined in FIG. 1, route b) was carried out. Under an inert atmosphere, endo,exo-5,6-dicarbomethoxynorbornene (63.4 mg, 0.30 mmol) (3) dissolved in CDCl3 (0.40 ml) was added to RuCl2(PCy3)2(=CHPh) (1) (Cy=cyclohexyl; Ph=phenyl) (10.0 mg, 12.1 μmol) dissolved in CDCl3 (0.40 ml). The reaction mixture was transferred to a Young's NMR tube. The system was monitored by ¹H NMR spectroscopy until the monomer was totally consumed (disappearance of monomer vinyl resonances at 6.10 and 6.25 ppm), ie the propagating species (Prop-3) had reacted substantially all of (3). After this time, (˜6 hours) 2-isopropoxystyrene (4b) (4.2 mg, 25.8 μmol-2 molar equivalents) dissolved in CDCl₃ (0.1 ml) was added to the solution. An extra 0.1 ml CDCl₃ was added to the reaction mixture to ensure all the isopropoxystyrene had been added. The reaction was monitored by ¹H NMR spectroscopy.

The NMR spectroscopy results showed cross metathesis occurred between the living chain-end of the polymer chains (Prop-3) and the 2-isopropoxystyrene (4b) and led to the conversion of the propagating Ru, moiety almost exclusively to Hoveyda's catalyst (2) and a chain-terminated polymer (Poly-3) after 45 minutes. After precipitation of the polymer (Poly-3), the initiator 2 may be recovered using standard grade solvent and silica gel chromatography and re-used in subsequent metathesis reactions.

### EXAMPLE 3

Under an inert atmosphere, endo,exo-5,6-dicarbomethoxynorbornene (642.9 mg, 3.09 mmol) dissolved in CDCl₃ (4.0 ml), was added to RuCl₂(PCy₃)₂(=CHPh) (Cy=cyclohexyl; Ph=phenyl) (102.9 mg, 9.125 mmol) dissolved in CDCl₃ (4.0 ml) and the solution was stirred. After 5 minutes, an aliquot (0.7 ml) of the solution was transferred to a Young's NMR tube and this was monitored by ¹H NMR spectroscopy until the monomer was totally consumed. After ˜4.5 hours, the aliquot was returned to the reaction mixture and 2-methoxystyrene (23.2 mg, 0.173 mmol) was added with stirring. An aliquot (0.7 ml) was taken and submitted for ¹H NMR spectroscopy. After 3 hours, the volume of the reaction mixture was reduced to ˜4 ml and it was added drop wise to hexane (˜80 ml) with stirring. The solution was filtered and the filtrate was concentrated in vacuo to yield a purple-brown solid (33 mg). The polymer was re-dissolved in chloroform (3 ml) and added drop wise to hexane (˜80 ml) with stirring. The solution was filtered and the filtrate was concentrated under vacuum to yield a brown powder (152 mg). The polymer was recovered as a grey powder (467 mg). The two recovered catalyst residues were combined and passed through a silica column (3:2 hexane:DCM) to yield 37 mg of Cl₂Ru(═CH-o-O-MeC₆H₄)PCy₃ (Me=methyl; Cy=cyclohexyl) (52% yield).

1. A polymerisation process comprising:
a) subjecting a cyclic alkene compound to a ring-opening metathesis polymerisation (ROMP) reaction using a transition metal ROMP catalyst which has an alkyl moiety which is connected to the metal centre thereof through a double bond; and
b) adding sufficient of an acyclic alkene having a carbon-carbon double bond capable of reacting with the catalytic metal moieties attached to the living end of each of the polymer chains generated in step a) to end cap the polymer chains and to generate a stable olefin metathesis catalyst.

2. A process according to claim 1 in which the ROMP metal catalyst used in step a) of the method is a transition metal catalyst, more preferably a molybdenum, tungsten, ruthenium, rubidium, rhodium or osmium catalyst; more particularly a molybdenum, ruthenium or osmium catalyst; and especially a ruthenium catalyst.

3. A process according to claim 1 in which the ROMP metal catalyst used in step a) has two electron-withdrawing and two electron-donating groups in addition to said alkyl moiety.

4. A process according to claim 3 in which the electron-withdrawing groups may be the same or different and are halogen or hetero-substituted aromatic groups or hetero-substituted aliphatic groups.

5. A process according to claim 3 in which the electron-donating groups may be the same or different and are phosphine ligands, more preferably PCy₃ where Cy is a cyclic aliphatic ring, preferably cyclohexyl, or are heterocyclic groups or a group, preferably oxygen, attached to the alkyl moiety.

6. A process according to claim 1 in which the alkyl moiety is an arylalkyl moiety, which moiety may be substituted on the aromatic ring.

7. A process according to claim 1 in which the catalyst used in step a) has the formula: 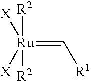
wherein:
R¹ is alkyl, aryl, alkylether, alkylthioether, arylether, arylthioether and in which, when R¹ contains an aryl component, the aryl component may be substituted, especially with electron withdrawing groups such as alkoxy groups;
R² are electron-donating groups which may be the same or different and are selected from PR₃³, wherein R³ is alkyl, such as iso-propyl, or is Cy wherein Cy is a cyclic aliphatic ring, preferably cyclohexyl, or is Ph wherein Ph is an aromatic ring, preferably phenyl, or a heterocyclic group, especially a heterocyclic group of formula: 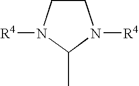
in which R⁴ is alkyl, aryl, arylalkyl; and
each X is an electron-withdrawing group which may the same or different and are selected from halogen, preferably chlorine, or hetero-substituted aromatic groups or hetero-substituted aliphatic groups such as aryloxy or alkoxy groups, especially phenoxy groups.

8. A process according to claim 7 in which the catalyst has other ligands attached, especially pyridine ligands, which may be substituted, especially halogen substituted, preferably Br substituted.

9. A process according to claim 1 in which the catalyst is attached to a support through one or more electron-donating groups and/or through one or more electron-withdrawing groups.

10. A process according to claim 1 in which the acyclic alkene used in step b) has a terminal double bond.

11. A process according to claim 1 in which the alkyl chain of the acyclic alkene used in step b) is lower alkyl, preferably between C₂ and C₁₂, more especially between C₂ and C₆.

12. A process according to claim 1 in which the acyclic alkene is an arylalkene.

13. A process according to claim 12 in which the alkyl chain is a C₂ chain.

14. A process according to claim 13 in which the aryl ring is a single ring which may be substituted.

15. A process according to claim 14 in which the ring is substituted in the ortho position with an alkoxy moiety, preferably a C₁ to C₁₂ alkoxy moiety, especially an isopropoxy moiety.

16. A process according to claim 1 in which, in step b), an arylalkene selected from styrene or 2-isopropoxystyrene is added to the reaction mixture.

17. A process according to claim 1 in which, in step b), the polymerisation reaction is substantially completed prior to the addition of the alkene.

18. A process according to claim 1 in which the amount of acyclic alkene used in step b) is at least one molar equivalent, and more especially is at least two molar equivalents.

19. A process according to claim 1 in which the amount of acyclic alkene used in step b) is not more than 10 molar equivalents, more especially not more than 5 molar equivalents.

20. A process according to claim 1 in which the amount of acyclic alkene used in step b) is between 1 and 10 molar equivalents, more especially between 2 and 5 molar equivalents.

21. A stable olefin metathesis catalyst recovered using a process according to claim 1.
